(19) United States
(12) Patent Application Publication
(10) Pub. No.: US 2011/0261795 A1
(43) Pub. Date: Oct. 27, 2011

(54) REDUNDANT CONNECTION OF RADIO NETWORK ELEMENTS TO A CENTRAL STATION

(75) Inventors: Philipp Honegger, Egg (CH); Urs Kästli, Mannedorf (CH); Philipp Blum, St. Niklausen (CH)

(73) Assignee: SIEMENS AKTIENGESELLSCHAFT, Muenchen (DE)

(21) Appl. No.: 13/002,553

(22) PCT Filed: Jul. 4, 2008
(86) PCT No.: PCT/EP2008/058700

§ 371 Date: Mar. 14, 2011

(51) Int. Cl. H04W 92/06

(52) U.S. Cl. 370/338

(57) ABSTRACT

A radio communication system has a central station, at least one slave radio station), a first gateway, and a second gateway. The slave radio station is coupled to the central station by way of a first transfer path using the first gateway and by way of a second transfer path using the second gateway. A method is detailed that provides for transferring data between a slave radio station and a central station of a radio communication system.

The present invention relates to the technical field of radio communication systems. In the context of this application, a communication network with several users is to be understood by ‘radio communication system’, with at least some users communicating with each other wirelessly via a radio interface. The present invention particularly relates to a radio communication system with a central station and at least one slave radio station, which are connected to each other by a gateway. The present invention also relates to a method for transferring data between a slave radio station and a central station of a radio communication system of the type described above.

In the field of building services engineering, radio communication systems designed as fire detection systems are known, in which the slave radio stations are connected to a central station by a gateway. The gateway typically ensures a conversion of ‘radio messages’ into ‘wire messages’ and vice versa. In this context, ‘radio messages’ are data which is transferred via a radio interface. ‘Wire messages’ are data which is transferred via a wire connection.

It is also known how to connect several slave radio stations to each other by means of a meshed network, which is denoted as a ‘mesh network’. Here a data transfer can also take place through other slave radio stations, which function as an intermediate station or as a repeater. A data transfer of this type is usually denoted as a ‘multi-hop’ transfer.

It is also known that inside a meshed multi-hop network, several radio transfer paths can exist between a chosen transmitting station and a chosen receiving station. Through this, a data transfer between the chosen transmitting station and a chosen receiving station can still be ensured, even after a failure of an intermediate station.

The object of the present invention is to further increase the transfer security inside a radio communication system.

This object is achieved by the items of the independent patent claims. Advantageous embodiments of the present invention are described in the dependent claims.

A radio communication system is described according to a first aspect of the invention. This comprises (a) a central station, (b) at least one slave radio station, (c) a first gateway and (d) a second gateway. According to the invention, the slave radio station is coupled with the central station by a first transfer path including the first gateway, and by a second transfer path including the second gateway.

The described radio communication system is based on the concept that, by using at least two gateways, the security in transfer of data between the slave radio station and the central station can be improved. A reliable data transfer is also particularly ensured if one of both gateways fails due to an error.

A network element which carries out a protocol conversion in particular is to be understood by the term ‘gateway’.

Here the gateway can independently carry out a suitable conversion of the data to be transferred between the slave radio station and the central station. Even an omission of information can be possible, if this cannot be transferred in the respective target network. In this way, for example, all protocol information, which is attached to a data packet, can be removed and replaced by other protocol information. A gateway can, in particular, carry out a conversion between ‘radio messages’ and ‘wire messages’ and vice versa.

Both of the gateways can also be denoted as network gateway devices between different network types, or between two different sections of a network.

At this point it is expressly noted that the present invention can also be realized with two or more gateways. In this way, the number of transfer paths between a slave radio station and the central station can be further increased, and therefore finally the transfer or communication security can also be further increased.

The central station can comprise an evaluation unit, which receives the communication signals of the slave radio station, and, if necessary, evaluates said communication signals in combination with one or several communication signals from other slave radio stations. In the case of a radio building management system or a radio alarm signal, several communication signals from different slave radio stations designed as measuring instruments and/or as an alarm system, for example, can be evaluated in combination. If necessary an alarm signal can be initiated, which prompts people who are in the area monitored by the alarm, for example inside a building, to leave the dangerous area.

The slave radio stations can also comprise output elements, such as actuators, for example. These include acoustic and/or visual display devices, such as alarm sirens or flashing lights. Output devices can also be electric switch contacts, which for example trip smoke vents or activate a sprinkler system. The same transfer paths between the central station and the respective slave radio stations can be used for activating the actuators.

The first and/or the second gateway can be directly or indirectly connected to the central station. A field bus, for example, can be used to connect the gateways to the central station.

According to a further embodiment of the invention, the first transfer path and the second transfer path are independent of each other.

By using at least two gateways, which are assigned to a separate transfer path in each case between the at least one slave radio station and the central station, the slave radio station is therefore connected to the central station by at least two completely independent transfer paths. In this context, it can be understood by the term ‘independent’ that between the slave radio station and the central station concerned, there is no part-route used by both transfer paths. The same also applies for both wired sections as well as for radio links. The connection of the slave radio station to the central station is completely first failure safe, due to the provision of transfer paths which are independent of each other. This means that inside a larger system, which, in particular, can comprise several slave radio stations, the functionality of the whole system is maintained, even in the event of a failure of any component of the system such as, for example, a radio link, a gateway or a wired connection.

The described redundant connection between the central station and the slave radio station by at least two transfer paths, which are separate from each other, has the advantage that a higher failure safety of the whole system can be achieved. On one hand, this is a direct advantage for the operator of the radio communication system, and on the other hand in the future it will make larger systems possible, i.e. systems with a higher number of slave radio stations than conventional communication systems, and therefore to ensure the relevant legal regulations for the radio alarm system regarding reliable operation.

It should be noted that the first gateway and/or the second gateway can optionally be arranged in a common housing, together with the central station. Furthermore the first gateway and/or second gateway can also be implemented inside the central station.

According to a further embodiment of the invention both gateways are coupled with the central station by means of a circular pipeline. In this context, a connecting pipeline can be understood by the term ‘circular pipeline’, which extends from a first connection of the central station to a second connection of the central station. This means that the gateways are at least also coupled with the central station by a wired connection.

In this context, a circular pipeline can facilitate an efficient wired connection of both of the gateways to the central station, in view of the required connection cable. Of course, the circular pipeline can also include one or several optical fibers, so that both of the gateways are connected by an optical connection to the central station.

Here the central station can be designed in such a way that, in the event of a simple break in the circular pipeline, both gateways are still connected to the central station. Communication between a slave radio station and the central station can therefore also take place via the same gateway. A change towards the use of the other gateway is thus not required for merely a simple interruption in the circular pipeline.

The communication between both of the gateways on the one side and the central station on the other side can also take place via a bus connection. This means that the devices connected to the circular pipeline are connected electrically parallel on the bus. In the described fault of a simple break in the circular pipeline, communication between the central station and one of both gateways takes place via the non-interrupted section of the circular pipeline. Communication is therefore still possible with both gateways via the non-interrupted section of the circular pipeline.

According to a further embodiment of the invention, at least one of both gateways is coupled with the central station by a separate stub. In the event of using several stubs, this means that only a single gateway is connected on only one stub. In this way, a failure in one stub can simply lead to the failure of one single gateway.

According to a further embodiment of the invention the central station comprises a first evaluation unit and a second evaluation unit. Both of the evaluation units are coupled with each other. Furthermore the first evaluation unit is connected to the first gateway and the second evaluation unit is connected to the second gateway. The connection of both of the gateways to both of the different evaluation units can therefore take place optionally by a circular pipeline and/or a stub.

The use of two separate evaluation units has the advantage that, in relation to at least some functions of the central station, a redundancy concerning the failure of one of both evaluation units can also be achieved. This applies in any case, then, if in the case of a failure of the first evaluation unit, at least one indirect communication between the second evaluation unit and the first gateway is possible via the failed first evaluation unit. The indirect communication can take place via the second gateway, for example. This applies in particular if the first and second gateways are connected to the central station by a common circular pipeline. In the event of a failure of the first evaluation unit, then all range check functions regarding the signals, which are provided by both different gateways, can be carried out by means of the second evaluation unit.

According to a further embodiment of the invention, the radio communication system comprises several slave radio stations, which form a meshed radio network.

For example, one subnet of the described radio communication system consisting of several slave radio stations can be understood by a meshed radio network. In this, the individual slave radio stations are connected to each other by a variety of radio interfaces. In particular, some slave radio stations can also indirectly communicate with each other via other slave radio stations.

The meshed radio network can be a so-called ad-hoc network, for example, which is able to be set up and configured independently. The meshed radio network can also be a so-called multi-hop network, in which data is passed on from slave radio station to slave radio station until it reaches its receiver.

In the creation of a meshed radio network with several slave radio stations, the advantage can optionally result that the data load is more advantageously distributed than in networks with a central contact point. Scarce resources such as computing time, energy and bandwidth require an effective co-operation of slave radio stations, which each function as network nodes. Through special routing procedures, it can be ensured that the ad-hoc network adapts itself independently, when network nodes move, are added or fail.

In particular when using a variety of slave radio stations, using a meshed network has the advantage that most slave radio stations send messages to a gateway via several connecting paths, and can receive messages from these. The transfer of messages then often takes place via so-called multi-hop connections, in which the transferred data is transferred indirectly via several slave radio stations. According to the invention, through the use of at least two gateways, a data transfer from and to the central station is therefore possible for most radio slave stations via redundant connecting paths, so that a particularly high failure safety of the whole radio communication system can be achieved.

However, it should also be noted that within the framework of the invention described in this application, even if it offers the greatest advantage in connection with a meshed connection from several slave radio stations regarding the first failure safety, several slave radio stations can also be connected to each other by means of other radio network technologies. Also when using other radio network technologies, an improved failure safety is achieved by the provision of two gateways as a result of the corresponding redundancy.

According to a further embodiment of the invention, at least some of the slave radio stations are assigned to one of two groups, with the slave radio stations assigned to one group (a) normally using one of both gateways for a data transfer from and/or to the central station in each case, and (b) only using the other gateway for a data transfer from and/or to the central station in the event of a failure of the first gateway.

Here the individual slave radio stations can preferably be assigned in groups in such a way that the best reliability and/or the highest speed is ensured for the normal data transfer path. As a rule the gateway which can be reached by using the fewest intermediate stations is used therefor for each slave radio station.

It should be noted that the slave radio stations can also be designed in such a way that they automatically choose the gateway which facilitates the best reliability and/or the best speed for the normal transfer path.

According to a further embodiment of the invention, the radio communication system is limited locally to a building or a complex of buildings.

The radio communication system, which is limited regarding its spatial extension, thus differs significantly from known cellular mobile radio networks, which cover a spatial area dependent on the number of individual cells, which goes considerably beyond the size of a building or a larger complex of buildings. The near field radio communication network described can have a spatial extension in one direction of 20 m, 50 m, 100 m, 200 m or 500 m, for example. It should be noted that a complex of buildings can also have buildings which are preferably next to each other. These can be connected to each other in particular by using a meshed network based on multi-hop technology as described above.

According to a further embodiment of the invention, the radio communication system is a radio building management system.

The building management system can be used for a variety of different operations, which are required and/or expedient inside a building furnished with modern equipment. So the building management system described can be used, for example, for climate control, operating the opening of doors and/or windows or room surveillance. The radio communication system can comprise a sensor network and/or an actuator network, which records measured values in each different room, and forwards these to the central station, and receives a switching or control command. Therefore, an integrated building management system can be achieved with the described building management system.

According to a further embodiment of the invention, the radio communication system is a radio alarm system.

Here the purpose of the described radio alarm system is typically specified by the functionalities of the individual slave radio stations. As a result, all slave radio stations can provide the same functionality or different functionalities. In the case of providing different functionalities, there can be an integrated building surveillance, regarding, for example (a) burglaries (intrusion protection) (b) floods, (c) should the occasion arise, emergence or permeation of gases which are dangerous to human health, and/or (d) the emergence of smoke. In addition to surveillance functions, slave radio stations in an alarm system can also have evacuation or control functions, such as, for example, closing fire doors or smoke valves, which can be controlled by the central station in dangerous situations. The radio communication system can be a fire alarm system, in particular. Since suitable peripheral equipment, which can be used as a slave radio station, is known to those skilled in the art in the field of alarm technology for all of these dangerous situations, possible concrete embodiments of such devices will not be discussed within the framework of this application.

It should be noted that, in particular, the creation of a meshed network by several slave radio stations is particularly advantageous in the field of alarm technology. Through the provision of completely redundant transfer paths between the central station and the individual slave radio stations, a particularly high failure safety can be achieved. In a radio communication system designed as a radio alarm system, this can be particularly advantageous, since due to a higher failure safety in some dramatic events, such as, for example, a dangerous fire situation, human lives could even be saved.

At this point it should be noted, purely as a precaution, that the radio communication system can also be a combination of a building management system and an alarm system.

According to a further aspect of the invention, a method is described for data transfer between a slave radio station and a central station of a radio communication system of the type described above.

The described data transfer method is based on the idea that the reliability of the data transfer can be improved by the provision of at least two different possible transfer paths between the slave radio station and the central station. According to the invention, both of the different transfer paths run via two different gateways. Therefore a faultless data transfer is then also ensured even when one of the two gateways fails due to an error.

According to an embodiment of the invention, the data is normally transferred redundantly via both the first transfer path as well as via the second transfer path. Here a condition of the described radio communication system, in which both the first as well as the second gateway are operational, is to be understood by the term ‘normally’.

The normally redundant data transfer has the consequence that the same data reaches the respective target network element, the slave radio station or the central station, via two transfer paths, which are preferably independent of each other. In order to avoid an unnecessary data collection in the target network element, several items of identical data present can be filtered and if necessary deleted. In this way it can be ensured that data processing operations effected in the target network element do not have to work with redundant data unnecessarily. The described filtering of data received several times can be carried out in the central station, in particular by an evaluation unit.

The lasting redundant transfer via more than one transfer path allows a simple checking of the integrity of all transfer paths, and therefore the assurance that all network elements stay connected, even in the event of a failure of an individual component or communication link.

It should be noted that provided that more than two transfer paths exist between a slave radio station and the central station, the data can normally be redundantly transferred by any number of the available transfer paths. Of course, a redundant data transfer is then only possible when the number of chosen transfer paths is greater than one.

According to a further embodiment of the invention, the data is transferred from a first network element to a second network element (a) normally, simply via the first transfer path, and (b) in the case of failure, via the second transfer path. Here the first network element can be the central station and the second network element can be the slave radio station. Alternatively, the second network element can be the central station, and the first network element can be the slave radio station.

Of course, if necessary, if the second transfer path is also interrupted, a further transfer path can similarly also be activated if available.

The described distribution of the data transfer between the normal situation and the failure situation can mean that in the case of an interruption in a transfer path, the communication is redirected to another transfer path. The redirection can be activated by the slave radio station and/or the central station. Activating the redirection can take place by an absent confirmation message, the confirmation message normally being returned by the gateway concerned, if the slave radio station and/or the central station sends a message to the gateway concerned.

It should be noted that the same messages or the same data can be transferred via the redirection as via the normal transfer path. This has the advantage that also in the event of a failure of a gateway, all data which would normally be transferred via the failed gateway can be transferred via the other gateway.

Communication between the central station and the respective slave radio stations can be carried out both bi-directionally as well as unidirectionally. A bi-directional communication means that data is transferred both from the respective slave radio station to the central station as well as from the central station to the respective slave radio station. This type of communication represents the normal case for most radio communication systems which are used in the field of building technology. However, a unidirectional communication is also possible. In the event of the respective slave radio station being equipped only with an input element, such as, for example, a sensor for recording a measured value, then the unidirectional communication takes place from the slave radio station towards the central station. In the event of the respective slave radio station being equipped only with an output element, such as, for example, an actuator, then the unidirectional communication takes place from the central station towards the slave radio station.

It should be noted that the transfer security can of course only be improved when the second or another transfer path is still available after a failure of the first transfer path, and can actually be used for data transfer.

In order to reliably monitor the availability of the second or redundant transfer path and if necessary, other redundant transfer paths, the following methods can be used, amongst others, which can be used alone or in any combination with each other:
Within the framework of a regular data transfer a periodic change takes place between all available transfer paths. In this way, a break in a transfer path can be quickly and reliably recognized.
Also, the second or redundant gateway, and, if necessary, the further redundant gateways will be monitored as network component(s) of the described radio communication system within the framework of an integrity check. This integrity check can be carried out in periodic time intervals.
Telegrams will be transferred in timely preferred periodic intervals between the different gateways, with which the sender reports a faultless operating condition to the other gateway or gateways. In this, the telegrams can be transferred directly or indirectly via the central station and/or individual slave radio stations.

According to a further embodiment of the invention, in the event of a failure, the current use of the second gateway is recognized by the first network element by means of a message received via the second transfer path. Furthermore an addressing is used for data to be transferred in future to the second network element, in which the use of the second transfer path is described.

The described correct addressing used by the sending network element after a failure of a gateway has the advantage that, in the case of failure, the correct path is already given to the receiver by sending the message. In this way, the security and also the speed of data transfer between the first and second network element or between the slave radio station and the central station can be improved considerably.

According to a further embodiment of the invention, in the case of failure, it is not recognized by the first network element that the data is transferred via the second transfer path, and messages are still addressed to the second network element in the same way as usual. This means that the first network element does not recognize an activated redirection of the data flow from the defective first gateway to the operational second gateway. Despite an addressing resulting from it, with an incorrect given transfer path, if necessary, a faultless data transfer to the correct target network element can take place, in which the operational gateway draws corresponding data and therefore ultimately ensures the implementation of the redirection from the first transfer path to the second transfer path.

According to a further embodiment of the invention, a radio communication system with several slave radio stations is used, and in the event of failure, data from at least one specified slave radio station is transferred to the central station in such a way that this keeps the identity of the at least one specified slave radio station hidden. This can, for example, be implemented by the corresponding messages of the slave radio station being transferred as a whole by the activated redirection via the second transfer path. In the case of a radio alarm system, the central station therefore does not have the possibility of identifying the individual slave radio station which issued an alarm.

Even if in the described, targeted hiding of the identity of the sender of a message, if necessary for assessing a dangerous situation, important data is not transferred by the central station, this hiding has at least the advantage that the extent of all the data, which in the described case of failure all has to run via the second gateway, can be reduced. In the case of a radio alarm system with a variety of slave radio stations, in a so-called ‘fail safe’, which only allows reduced operating of the system, the amount of data to be transferred via the second gateway or via the remaining gateways can be reduced by omitting corresponding sender information.

Further advantages and features of the present invention result from the following exemplary description of current preferred embodiments. The individual figures of the drawings of this application are simply schematic and are not to be considered as true to scale.

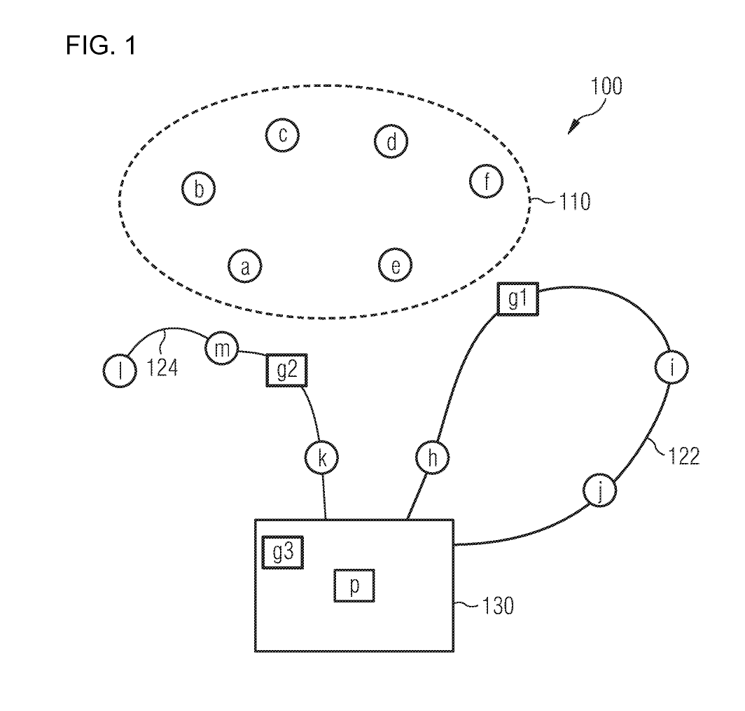

FIG. 1 shows a radio alarm system with three gateways, with a first gateway being connected to a central station by a circular pipeline and a second gateway being connected to a central station by a stub, and with a third gateway being integrated into the central station.

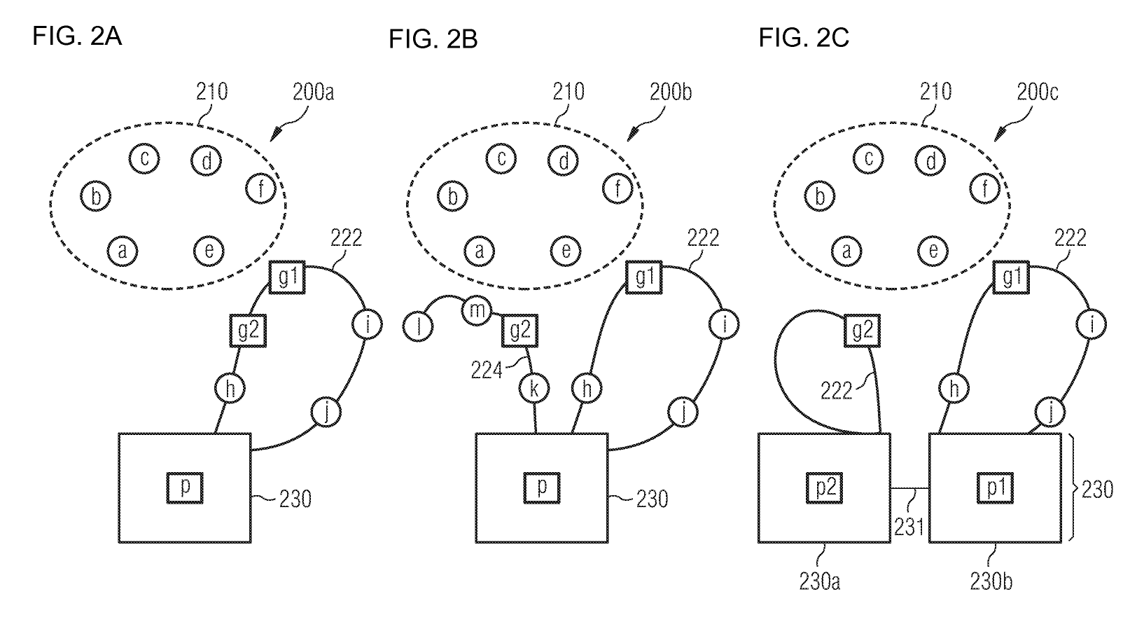

FIGS. 2a, 2b and 2c show three different radio alarm systems, each with a different connection of two external gateways to a central station.

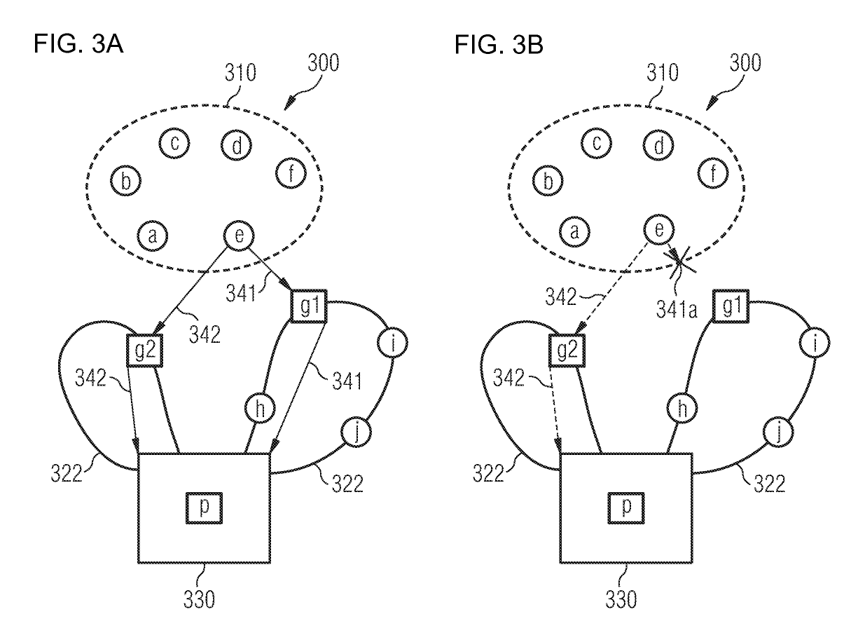

FIGS. 3a and 3b show the transfer of a basically redundant data transfer in a normal case (FIG. 3a), and of a redundant data transfer only activated in the event of a failure (FIG. 3b).

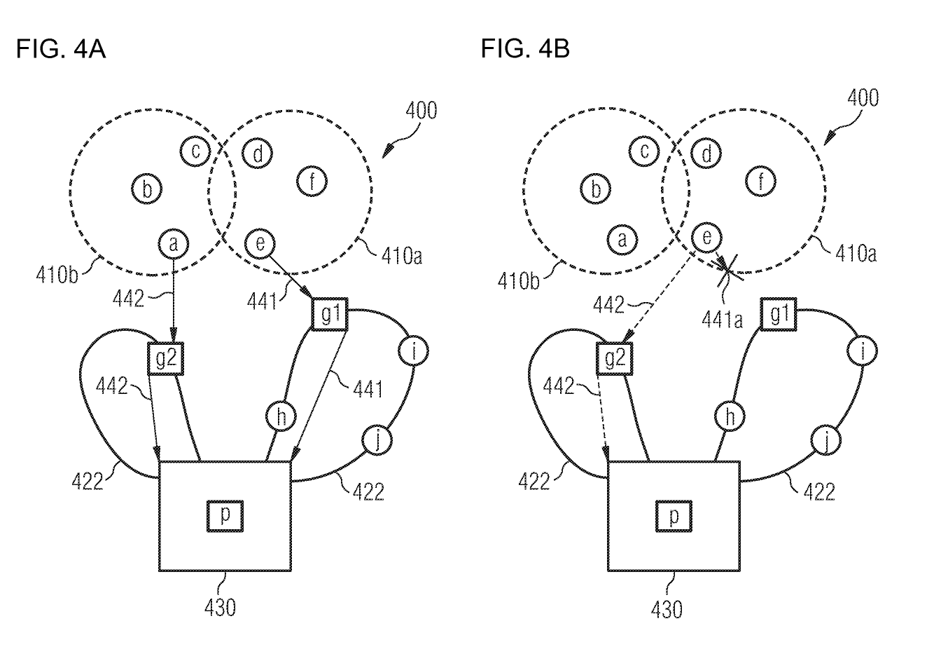

FIGS. 4a and 4b show a radio alarm system with two radio networks neighboring each other, to which a gateway is attached in each case with, in the event of a failure of a gateway, the data transfer being capable of being maintained via the other gateway.

At this point it is to be noticed that in the drawings, the reference characters simply differ by their first digit from the same components or those corresponding to each other. Letters used as reference characters for network elements are only used in the drawings for network elements corresponding to each other.

FIG. 1 shows a radio communication system 100 designed as a radio alarm system. The radio alarm system 100 comprises a meshed radio network 110, which includes a variety of slave radio stations a, b, c, d, e, f. The slave radio stations a, b, c, d, e, f are coupled with each other by at least single-hop or by multi-hop communication connections.

Furthermore the radio communication system 100 comprises two external gateways g1 and g2 and a central station 130. The gateway g1 is connected to the central station 130 by a circular pipeline 122. The circular pipeline 122 also extends over further network elements h, i, j. The network elements h, i, j can comprise the same functionalities inside of the radio alarm system 100 as the slave radio stations a, b, c, d, e, f. Therefore, in the case of the fire alarm system, the network elements h, i, j can comprise fire detectors, input/output modules, alarm devices, display units, operator units, etc. The same applies to building management systems.

The decisive difference between the network elements h, i, j and the slave radio stations a, b, c, d, e, f is the result of the type of communication with the central station and the respective energy supply resulting from it. The network elements h, i, j can communicate via wires with the central station 130, whereas the slave radio stations a, b, c, d, e, f are at least partly dependent on a wireless radio communication. Since the slave radio stations a, b, c, d, e, f are typically subjected to additional limitations regarding power requirement, supply voltage, size, electrical connections etc., functionalities, for example, which have a particularly high power requirement, are preferably provided in conjunction with network elements, which are connected to the central station by wires. This applies for example for so-called linear fire detectors, which show smoke by means of extinguishing caused by smoke aerosols. This also applies for flame detectors, xenon flasher lamps and/or display and operator units.

The use of a circular pipeline for connection of the gateway g1 to the central station 130 has the advantage that in the event of a break of simply a branch of the circular pipeline 122, the gateway can communicate with the central station 130 via the other branch of the circular pipeline 122. The circular pipeline 122, which extends out of the central station 130 via the gateway g1 back to the central station 130, therefore provides two transfer paths which are independent of each other for communication between gateway g1 and central station 130.

The gateway g2 is connected to the central station 130 by means of a stub 124. The stub 124 also extends over further network elements k, l, m. The network elements k, l, m can carry out the same tasks inside the radio alarm system 100 as the network elements h, i, j, which are arranged inside the circular pipeline 122.

At this point it should be noted that, for many aspects of the invention, it is insignificant whether the gateways are connected to the central station by a circular pipeline or by a stub. With this in mind, the type of pipeline by which the gateways are connected to the central station is insignificant. The same applies for the radio alarm systems subsequently shown by FIGS. 2a, 2b, 2c, 3a, 3b, 4a and 4b, even if the connection is only shown by a circular pipeline in each case.

Both of the gateways g1 and g2 provide in a known way for a conversion between ‘radio messages’ from and for at least one slave radio station of the meshed radio network 110, and ‘wire messages’ from and for the central station 130. In particular, the gateways g1 and g2 can carry out a protocol conversion. According to the embodiment shown here, the central station 130 comprises an evaluation unit p, which receives messages provided from the individual slave radio stations a, b, c, d, e, f and possibly evaluates them in combination with each other. For example, a corresponding fire alarm signal can be initiated by the evaluation unit from a message from a slave radio station, which is designed as a fire alarm. Through an alarm of this type, for example, people who are inside a building monitored by the radio alarm in question can be prompted to leave the dangerous area.

The radio communication system 100 also comprises a further gateway g3. According to the embodiment shown here, the further gateway g3 is integrated into the central station 130. The gateway g3 can also be used for the connection of slave radio stations a, b, c, d, e, f to the central station 130. Of course, for increasing the communication security between the central station 130 and the slave radio stations a, b, c, d, e, f, yet further gateways can also be used.

FIGS. 2a, 2b and 2c show three different radio alarm systems 200a, 200b and 200c, which in each case comprise a meshed network 210, with a variety of slave stations a, b, c, d, e, f, two gateways g1 and g2 and a central station 230.

In the alarm system 200a shown in FIG. 2a, both of the gateways g1 and g2 are coupled with the central station 230 by the same circular pipeline 222.

In the alarm system 200b shown in FIG. 2b, the gateway g1 is coupled with the central station 230 by a circular pipeline 222. The gateway g2 is coupled with the central station 230 by a stub 224. It is relevant here that the gateways g1 and g2 are connected to the central station 230 by different pipelines 222, 224. Whether these pipelines are designed as circular pipelines or stubs is insignificant here.

In the alarm system 200c shown in FIG. 2c, the central station comprises two units 230a and 230b which are spatially separated from each other. The unit 230a is assigned a first evaluation unit p1 and the unit 230b is assigned a second evaluation unit p2. Both units 230a, 230b are coupled with each other by a communication link 231. The communication link 231 can be a wireless connection (for example, via radio) and/or a wired connection (for example, by an optical fiber or a metallic pipeline). The connection 231 can be implemented not only as a single but also as a multi connection, for example, by means of a circular pipeline.

FIGS. 3a and 3b show the transfer of a basically redundant data transfer in a normal case for a radio alarm system 300 to a non redundant data transfer in the event of failure. According to the embodiment shown here, the radio alarm system 300 shows a meshed radio network 310 with a variety of slave stations a, b, c, d, e, f, two gateways g1 and g2 and a central station 330. Each gateway g1 and g2 is connected to the central station 330 by its own circular pipeline 322. For the purposes of processing the input signals or input messages received from different slave radio stations, the central station 330 comprises an evaluation unit p.

Normally, that is to say, if all network elements of the radio alarm system 300 and in particular both gateways g1 and g2 are operational, the slave radio station e is, for example, connected to the central station 330 by two transfer paths completely separate from each other, a first transfer path 341 and a second transfer path 342. The first transfer path 341 runs via gateway g1, the second runs via gateway g2. This situation, which is distinguished by a completely redundant data transfer between the central station 330 and the slave radio station, is shown in FIG. 3a.

Here all data is redundantly transferred between the slave radio station e and the central station 330. This means that all data is transmitted twice to the central station 330 or to the evaluation unit p. In order to avoid an unnecessary collection of data in the central station 330 or in the evaluation unit p, a suitable data filtering can be carried out here, in which redundant data is deleted.

For example, should the first transfer path 341 be broken by a failure 341a, then a data transfer is only possible via the second transfer path 342. This failure situation, which is due, in particular, to a failure of the gateway g1, is illustrated in FIG. 3b. If the second transfer path 342 has sufficient bandwidth, all data, which is transferred undisturbed via the first transfer path 341 is undirected to the second transfer path 342.

Of course, it is also possible that normally the data is not redundantly transferred, but simply transferred from the slave radio station e to the central station 330 via the gateway g1. In the event of a failure of the gateway g1 or a communication link linked to the gateway g2, then the redundancy regarding possible transfer paths can be activated, so that the future communication between the slave radio station e and the central station 330 takes place via the second gateway g2. The recognition of the failure of the first gateway g1 can be performed by the evaluation unit p, for example, by a ‘failure’ message received by the gateway directly or indirectly via a slave radio station, and/or the absence of positive ‘operation’ messages (so-called ‘keep alive’ messages). Both ‘failure’ messages as well as positive ‘operation’ messages can be transferred to other users of the radio communication system via all available paths and routes. These paths and/or routes can include, for example, a leaded fieldbus as a stub or circular pipeline, radio links and/or additional connections, for example, via wire, radio or optical fibers.

FIGS. 4a and 4b show two operating conditions of a radio alarm system 400. The alarm system 400 comprises two radio networks 410a and 410b neighboring each other. The radio networks 410a or 410b can, for example, be a meshed network with a variety of slave radio stations a, b, c, or d, e, f. A gateway g1 is assigned to the first radio network 410a for the communication of the slave stations concerned and the central station 430. Correspondingly, a gateway g2 is assigned to the second radio network 410b.

In a failure-free operating condition, shown in FIG. 4, in which in particular both of the gateways g1 and g2 are operational, communication between the slave radio station e and the central station 430 takes place via the gateway g1, which defines a first transfer path 441. Communication between the slave radio station a and the central station 430 takes place via the gateway g2, which defines a second transfer path 442.

In the event of a failure of the gateway g1, or a failure of the communication link between the gateway g1 and the slave radio station e, or between the gateway g1 and the central station 430, the data traffic between the slave radio station e, which normally runs via the first transfer path 441, is redirected to the second transfer path 442. This operating condition is shown in FIG. 4b. Therefore, a seamless data transfer between the slave station e and the central station 430 can also be ensured in the event of a failure or in the event of a break of the first transfer path 441.

It should be noted that the embodiment described here simply represents a limited selection of possible design variants. Therefore it is possible to combine the features of individual embodiments with each other in appropriate ways, so that, for those skilled in the art, a variety of different embodiments can be considered to have been disclosed clearly with the design variants explicitly shown here.

1-16. (canceled)

17. A radio communication system comprising
a central station;
at least one slave radio station;
a first gateway; and
a second gateway;
wherein said slave radio station is coupled with said central station
by way of a first transfer path including said first gateway; and
by way of a second transfer path including said second gateway.

18. The radio communication system according to claim 17, wherein said first transfer path and said second transfer path are independent from one another.

19. The radio communication system according to claim 17, which comprises a circular pipeline coupling said first and second gateways with said central station.

20. The radio communication system according to claim 17, which comprises a separate stub coupling at least one of said first and second gateways with said central station.

21. The radio communication system according to claim 17, wherein said central station comprises a first evaluation unit and a second evaluation unit connected to said first evaluation unit, and wherein said first evaluation unit is connected to said first gateway, and said second evaluation unit is connected to said second gateway.

22. The radio communication system according to claim 17, which comprises a plurality of slave radio stations together forming a meshed radio network.

23. The radio communication system according to claim 22, wherein at least some of said slave radio stations are assigned to one of two groups, and the slave radio stations assigned to a common group:
normally using one of said first and second gateways for data transfer from and/or to said central station in each case; and
using the other one of said first and second gateways for data transfer from and/or to said central station only in the event of a failure of said first gateway.

24. The radio communication system according to claim 17, implemented as a radio communication system that is spatially limited to a building or a complex of buildings.

25. The radio communication system according to claim 24, configured as a building management system.

26. The radio communication system according to claim 23, implemented as a radio alarm system.

27. A method of transferring data, the method which comprises:
providing a communications system according to claim 17; and
transferring data between a slave radio station and the central station of the radio communication system.

28. The method according to claim 27, wherein the transferring step comprises, in normal operation, transferring the data redundantly both via the first transfer path and via the second transfer path.

29. The method according to claim 27, which comprises:
transferring the data
in normal operation, only via the first transfer path; and
in the event of failure, via the second transfer path from a first network element to a second network element;
and wherein:
the first network element is the central station and the second network element is the slave radio station; or
the second network element is the central station and the first network element is the slave radio station.

30. The method according to claim 29, which comprises, in the event of a failure of the first network element:
recognizing the current use of the second gateway by way of a message received via the second transfer path; and
for future data to be transferred to the second network element, using an addressing wherein the use of the second transfer path is described.

31. The method according to claim 28, wherein, if the event of a failure is not recognized by the first network element, transferring the data via the second transfer path, and furthermore addressing the messages to the second network as in normal operation.

32. The method according to claim 28, which comprises providing the radio communication system with a plurality of slave radio stations, and in the event of failure, transmitting data from at least one specified slave radio station to the central station and thereby hiding an identity of the at least one specified slave radio station.
